(19) United States
(12) Patent Application Publication
(10) Pub. No.: US 2005/0255920 A1
(43) Pub. Date: Nov. 17, 2005

(54) System and method for providing online game service via phone-to-phone connection

(76) Inventors: Cheng-Shing Lai, Taipei (TW); Xianlun Jiang, Nianjing City (CN); Yongcai Bian, Nianjing City (CN)

Correspondence Address: BIRCH STEWART KOLASCH & BIRCH, PO BOX 747, FALLS CHURCH, VA, 22040-0747, US

(21) Appl. No.: 10/844,357

(22) Filed: May 13, 2004

(51) Int. Cl. G06F 17/00; G06F 19/00

(52) U.S. Cl. 463/41

(57) ABSTRACT

A wireless communication terminal, providing an online game service using phone-to-phone connection. The wireless communication terminal comprises a transceiver, a multi-entry directory, a game execution module, and an online game control module. The transceiver communicates with a second wireless communication terminal. The multi-entry directory comprises an access number establishing phone-to-phone connection with the second wireless communication terminal. The game execution module stores and executes a game program. The online game control module, connected to the transceiver and the game execution module, directs the transceiver on behalf of the game execution module, and relays data between the transceiver and the game execution module.

### BACKGROUND OF THE INVENTION

1. Field of the Invention

The present invention relates to online game service and particularly to a system and method for providing online game service via phone-to-phone connection between two wireless communication terminals.

2. Description of the Related Art

In conventional gaming, portable game consoles, such as Gameboy handhelds, have not allowed gamers to play against others online. Recently, some handheld developers have provided machines that allow peer-to-peer online gaming using infrared connections for data transmission. In order to establish infrared connections between two handhelds, infrared transceivers thereof have to be aligned. When the infrared transceivers fail to align, disconnection occurs. The infrared connection, therefore, is not reliable for executing peer-to-peer online games.

Although many current mobile phones provide games onboard by color screens and fast processors, significant access fees are still a barrier for wide use of handsets for peer-to-peer online games.

Hence, there is a need for a handheld game console that addresses the problems arising from the existing technology.

### SUMMARY OF THE INVENTION

It is therefore an object of the invention to provide a system and method providing an online game service. To achieve this and other objects, the present invention provides a system and method for providing an online game service via a phone-to-phone connection between two wireless communication terminals.

According to the invention, a wireless communication terminal is provided. The wireless communication terminal comprises a transceiver, a multi-entry directory, a game execution module, and an online game control module. The transceiver communicates with a second wireless communication terminal. The multi-entry directory comprises an access number for establishing the phone-to-phone connection with the second wireless communication terminal. The game execution module stores and executes a game program. The online game control module, connected to the transceiver and the game execution module, directs the transceiver on behalf of the game execution module, and relays data between the transceiver and the game execution module.

The invention also provides a method for providing an online game service via a phone-to-phone connection using the wireless communication terminal described above. The online game service uses a phone-to-phone connection between a first and second wireless communication terminals. To initiate an interactive game actively, first an access number corresponding to the second wireless communication terminal is selected from a multi-entry directory of the first wireless communication terminal. It is then determined whether the first wireless communication terminal is operating in the phone-to-phone connection mode. A phone-to-phone connection is then established between the first and second wireless communication terminal. A game program stored in the first wireless communication terminal is then executed.

To initiate an interactive game passively upon a connection request, it is first determined whether the first wireless communication terminal is operating in the phone-to-phone connection mode. When a connection request is received from the second wireless communication terminal, the phone-to-phone connection is established between the first and second wireless communication terminals. A game program stored in the first wireless communication terminal is then executed.

The above-mentioned method may take the form of program code embodied in a computer readable tangible media. When the program code is loaded into and executed by a machine, the machine becomes an apparatus for practicing the invention.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a wireless communication terminal according to the present invention;

FIG. 2 is a flowchart of a method for initiating an interactive game actively according to the present invention;

FIG. 3 is flowchart of a method for initiating an interactive game passively according to the present invention; and

FIG. 4 is a diagram of a storage medium storing a computer program providing an online game service of the present invention.

### DETAILED DESCRIPTION

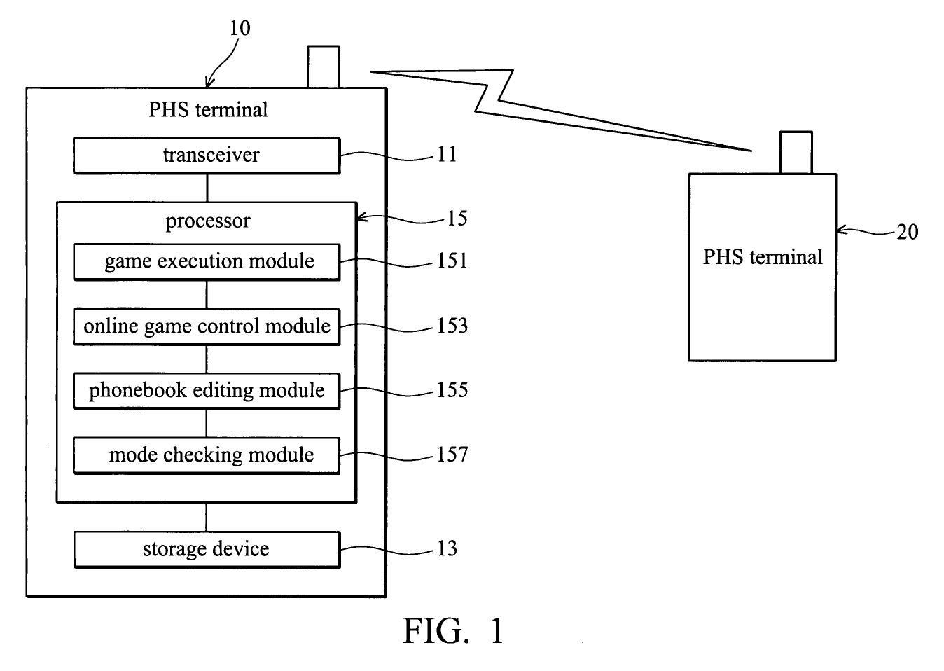

The present invention will now be described with reference to FIGS. 1 to 4, which in general relate to a wireless communication terminal providing an online game service via a phone-to-phone connection. The phone-to-phone connection enables direct call setup and communication between wireless subscribers without involving network infrastructure. Thus, the phone-to-phone connection incurs no access fees for subscribers, providing a less costly online game service.

FIG. 1 is a schematic view of a wireless communication terminal according to the present invention. FIG. 1 shows, as an example, a wireless communication terminal 10, a Personal Handy phone System (PHS), comprising a transceiver 11, a storage device 13, and a processor 15. The wireless communication terminal 10 is referred to as a PHS terminal in the specification.

The transceiver 11 communicates with a PHS terminal 20. The transceiver 11 sends a connection request to the PHS terminal 20 for establishing the phone-to-phone connection. The transceiver 11 operates in a walkie-talkie mode according to a PHS protocol. In the walkie-talkie mode, a phone-to-phone connection is established to transmit data between the PHS terminals 10 and 20 without a local wireless station. The connection via walkie-talkie mode thus incurs no access fees for the subscribers using the PHS terminals 10 and 20.

The processor 15 comprises a game execution module 151, online game control module 153, directory editing module 155, and mode checking module 157. The game execution module 151 executes a game program 131 stored in the storage device 13. The online game control module 153, connected to the transceiver 11 and the game execution module 151, directs the transceiver 11 on behalf of the game execution module 151, and relays data between the transceiver 11 and the game execution module 151. The online game control module 153 selects an access number corresponding to the PHS terminal 20 for establishing the phone-to-phone connection. The directory editing module 155 adds and/or deletes an access number in a multi-entry directory 133, wherein the access number establishes the phone-to-phone connection with a PHS terminal. The multi-entry directory 133 is stored in the storage device 13. The mode checking module 157 determines whether the PHS terminal 10 is operating in a walkie-talkie mode that can establish a phone-to-phone connection.

The storage device 13 stores the game program 131 and multi-entry directory 133. The multi-entry directory 133 comprises an access number establishing the phone-to-phone connection with the PHS terminal 20. Users can add an access number in the multi-entry directory 133 to establish a phone-to-phone connection with another PHS terminal. Users can also delete any access number from the multi-entry directory 133.

The invention also provides a method providing an online game service via phone-to-phone connection using the PHS terminal 10 described above. The online game service uses a phone-to-phone connection between the PHS terminals 10 and 20 to transmit data therebetween.

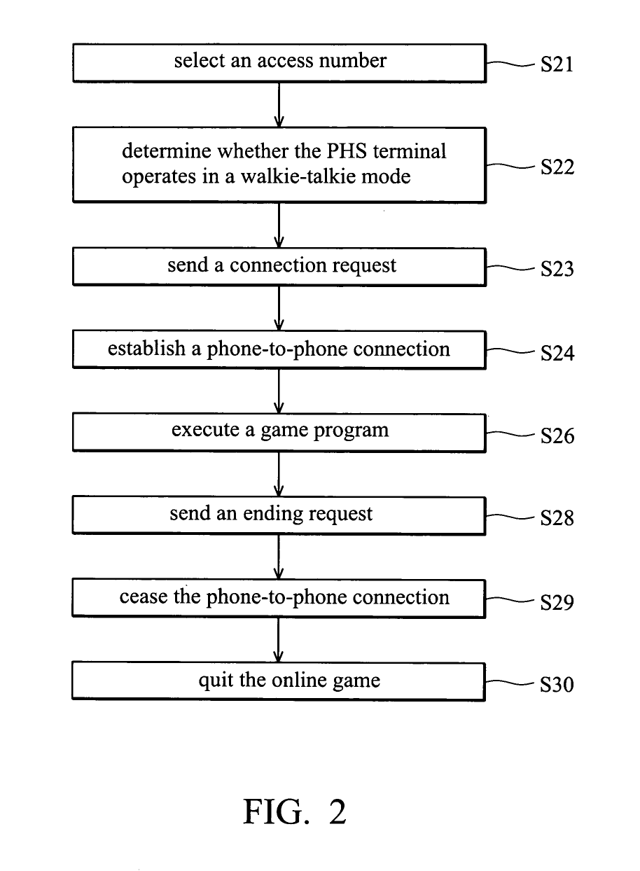

FIG. 2 is a flowchart of a method for initiating an interactive game actively according to the present invention.

First an access number corresponding to the PHS terminal 20 is selected from the multi-entry directory 133 stored in the PHS terminal 10 (step S21). The PHS terminals 10 and 20 are registered in a communication group which can communicate using packet communication in PHS walkie-talkie mode. The use of PHS packet communication capability does not require access fees to the PHS operators. Of course, the PHS terminals used in this service will also be able to access the public PHS network.

It is then determined whether the PHS terminal 10 is operating in a walkie-talkie mode (step S22). If so, a connection request is sent to the second PHS terminal 20 to establish a phone-to-phone connection (step S23). A phone-to-phone connection is then established between the PHS terminals 10 and 20 (step S24). The game program 131 stored in the PHS terminal 10 is then executed (step S26).

To quit the online game, an end request is sent (step S28) The phone-to-phone connection is then terminated (step S29), and the online game is over (step S30).

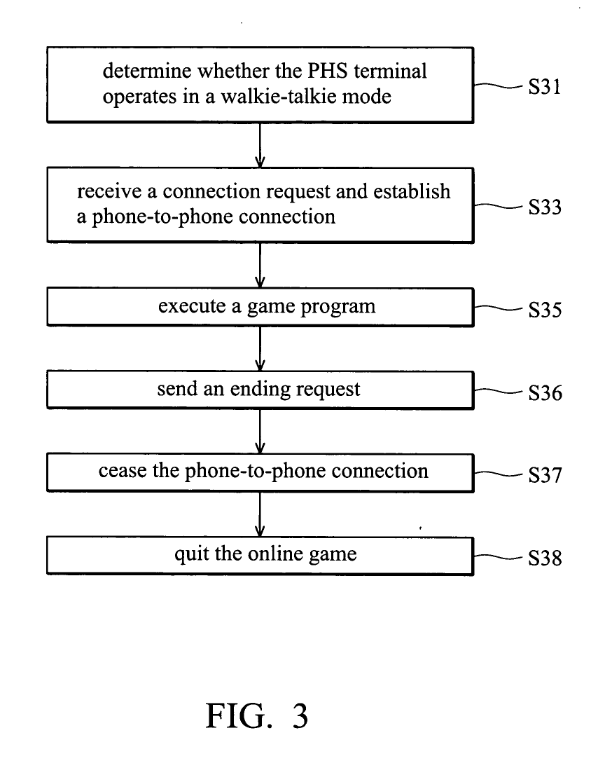

FIG. 3 is a flowchart of a method for initiating an interactive game passively according to the present invention.

To initiate an interactive game passively upon a connection request, it is first determined whether the PHS terminal 10 is operating in walkie-talkie mode (step S31).

When a connection request is received from the PHS terminal 20, the phone-to-phone connection is established between the PHS terminals 10 and 20 (step S33). The game program 131 stored in the PHS terminal 10 is then executed (step S35).

To stop the online game, an end request is sent from the PHS terminal 10 (step S36). The phone-to-phone connection is then terminated (step S37), and the online game is over (step S38).

The method for online game service of the present invention, or certain aspects or portions thereof, may take the form of program code (i.e. instructions) embodied in a tangible media, wherein, when the program code is loaded into and executed by a machine, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, the machine becomes an apparatus for practicing the invention. When implemented on a general-purpose processor, the program code combines with the processor to provide a unique apparatus that operates analogously to specific logic circuits.

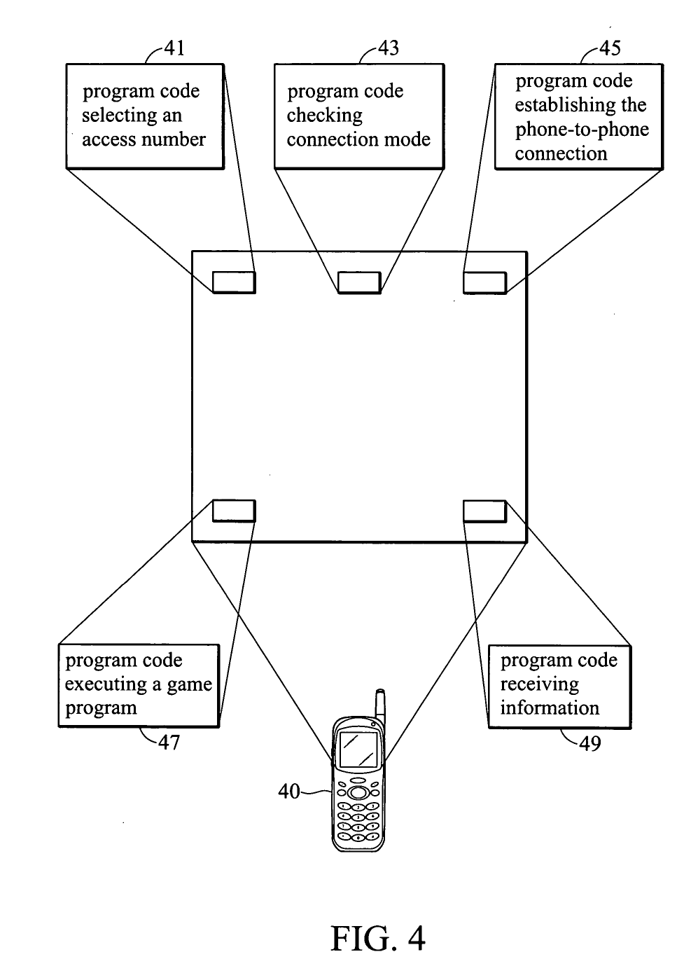

FIG. 4 is a schematic diagram of a storage medium for a program enabling the method for providing an interactive online game service according to the present invention. The program product includes a storage medium having machine readable program code embodied for use in a system 40, the machine readable program code comprising at least machine readable program code 41 selecting an access number corresponding to a second wireless communication terminal from a multi-entry directory of a first wireless communication terminal, machine readable program code 43 determining whether the first wireless communication terminal is operating in the phone-to-phone connection mode, machine readable program code 45 establishing the phone-to-phone connection, machine readable program code 47 executing a game program stored in the first wireless communication terminal, and machine readable program code 49 receiving information.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A wireless communication terminal, providing an online game service using a phone-to-phone connection, comprising:
a transceiver, communicating with a second wireless communication terminal;
a multi-entry directory, comprising an access number for establishing the phone-to-phone connection with the second wireless communication terminal;
a game execution module executing a game program; and
an online game control module, connected to the transceiver and the game execution module, directing the transceiver on behalf of the game execution module, and relaying data between the transceiver and the game execution module.

2. The wireless communication terminal of claim 1, wherein the transceiver performs in a walkie-talkie mode according to a personal handy-phone system (PHS) protocol.

3. The wireless communication terminal of claim 1, further comprising an entry-adding module, adding a second access number in the multi-entry directory establishing the phone-to-phone connection with a third wireless communication terminal.

4. The wireless communication terminal of claim 1, further comprising an entry-deleting module, deleting the access number from the multi-entry directory establishing the phone-to-phone connection with the second wireless communication terminal.

5. The wireless communication terminal of claim 1, further comprising a mode checking module determining whether the wireless communication terminal is operating in the phone-to-phone connection mode.

6. The wireless communication terminal of claim 1, wherein the online game control module further selecting the access number corresponding to the second wireless communication terminal for establishing the phone-to-phone connection.

7. The wireless communication terminal of claim 1, wherein the transceiver further sending a connection request to the second wireless communication terminal for initiating the phone-to-phone connection.

8. A method for providing an online game service using a phone-to-phone connection between a first and second wireless communication terminals, comprising:
providing the first wireless communication terminal;
selecting an access number corresponding to the second wireless communication terminal from a multi-entry directory of the first wireless communication terminal;
checking whether the first wireless communication terminal is operating in the phone-to-phone connection mode;
establishing the phone-to-phone connection between the first and second wireless communication terminal; and
executing a game program stored in the first wireless communication terminal.

9. The method of claim 8, further sending an end request to end online games in progress.

10. A method for providing an online game service using a phone-to-phone connection between a first and second wireless communication terminals, comprising:
providing a first wireless communication terminal;
determining whether the first wireless communication terminal is operating in the phone-to-phone connection mode;
receiving a connection request from the second wireless communication terminal;
establishing the phone-to-phone connection between the first and second wireless communication terminal; and
executing a game program stored in the first wireless communication terminal.

11. The method of claim 10, further sending an end request to stop an online game in progress.

12. A computer readable storage medium storing a computer program providing a method for online game service using a phone-to-phone connection between first and second wireless communication terminals, the method comprising:
selecting an access number corresponding to the second wireless communication terminal from a multi-entry directory of the first wireless communication terminal;
determining whether the first wireless communication terminal is operating in the phone-to-phone connection mode;
establishing the phone-to-phone connection between the first and second wireless communication terminals; and
executing a game program stored in the first wireless communication terminal.

13. The storage medium of claim 12, wherein an end request is further sent to stop online games in progress.

14. A computer readable storage medium storing a computer program providing a method for online game service using a phone-to-phone connection between first and second wireless communication terminals, the method comprising:
determining whether the first wireless communication terminal is operating in the phone-to-phone connection mode;
receiving a connection request from the second wireless communication terminal;
establishing phone-to-phone connection between the first and second wireless communication terminals; and
executing a game program stored in the first wireless communication terminal.

15. The storage medium of claim 14, wherein an end request is further sent to stop online games in progress.
